(19) United States
(12) Patent Application Publication
(10) Pub. No.: US 2019/0147548 A1
(43) Pub. Date: May 16, 2019

(54) CREATION AND MANAGEMENT OF COMMUNITY NETWORKS

(71) Applicant: International Business Machines Corporation, Armonk, NY (US)

(72) Inventors: Levente Klein, Tuckahoe, NY (US); Mariana Lazar, Tuckahoe, NY (US); Fernando J. Marianno, New York, NY (US); Dhruv Nair, Brooklyn, NY (US)

(21) Appl. No.: 15/811,739

(22) Filed: Nov. 14, 2017

(51) Int. Cl. G06Q 50/00; G06F 17/30; G06Q 10/10; G06Q 30/02; G06Q 30/06; H04L 12/58

(52) U.S. Cl. CPC G06Q 50/01; G06F 17/30867; G06Q 10/1095; H04L 51/16; G06Q 30/0611; G06Q 30/0202; H04L 51/32; G06Q 30/0282

(57) ABSTRACT

An aspect includes identifying, by a processor, a plurality of data sources associated with a defined geographic area. A plurality of scheduling data associated with a plurality of users is gathered from the data sources across a communication network. One or more shared activities and interests are identified based at least in part on the scheduling data and/or overlapping and similar proximity of user locations. One or more community networks that link two or more of the data sources are created based at least in part on the one or more shared activities and interests. One or more notifications associated with the one or more shared activities and interests are distributed across the one or more community networks.

### BACKGROUND

The present invention generally relates to computer technology, and more specifically, to dynamic creation and management of scheduling for members of community networks between a plurality of data sources.

Many people individually schedule overlapping activities in terms of location and time. Many people also share common interests without necessarily knowing other people in close geographic proximity who share the same interests. Within a community of people, task scheduling by individuals can result in multiple people performing similar tasks, and an inefficient allocation of resources with redundant actions adding to delays and resulting in resource contention.

### SUMMARY

Embodiments of the present invention are directed to a computer-implemented method. A non-limiting example of the computer-implemented method includes identifying, by a processor, a plurality of data sources associated with a defined geographic area. A plurality of scheduling data associated with a plurality of users is gathered from the data sources across a communication network. One or more shared activities and interests are identified based at least in part on the scheduling data and/or overlapping and similar proximity of user locations. One or more community networks that link two or more of the data sources are created based at least in part on the one or more shared activities and interests. One or more notifications associated with the one or more shared activities and interests are distributed across the one or more community networks.

Embodiments of the present invention are directed to a system. A non-limiting example of the system includes a memory and a processor communicatively coupled with the memory. The processor is configured to identify a plurality of data sources associated with a defined geographic area. A plurality of scheduling data associated with a plurality of users is gathered from the data sources across a communication network. One or more shared activities and interests are identified based at least in part on the scheduling data and/or overlapping and similar proximity of user locations. One or more community networks that link two or more of the data sources are created based at least in part on the one or more shared activities and interests. One or more notifications associated with the one or more shared activities and interests are distributed across the one or more community networks.

Embodiments of the invention are directed to a computer program product including a computer readable storage medium having program instructions embodied therewith. The program instructions are executable by a processing circuit to cause the processing circuit to perform a method. A non-limiting example of the instructions cause the processing circuit to identify a plurality of data sources associated with a defined geographic area. A plurality of scheduling data associated with a plurality of users is gathered from the data sources across a communication network. One or more shared activities and interests are identified based at least in part on the scheduling data and/or overlapping and similar proximity of user locations. One or more community networks that link two or more of the data sources are created based at least in part on the one or more shared activities and interests. One or more notifications associated with the one or more shared activities and interests are distributed across the one or more community networks.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to embodiments of the present invention;

FIG. 2 depicts abstraction model layers according to embodiments of the present invention;

FIG. 3 depicts a system according to one or more embodiments of the present invention;

FIG. 4 depicts a computer system according to one or more embodiments of the present invention;

FIG. 5 depicts a plurality of data sources associated with a defined geographic area, according to one or more embodiments of the present invention;

FIG. 6 depicts a community network, according to one or more embodiments of the present invention;

FIG. 7 depicts a grouping process, according to one or more embodiments of the present invention;

FIG. 8 depicts a graph matching users to an activity, according to one or more embodiments of the present invention;

FIG. 9 depicts another graph matching users to an activity, according to one or more embodiments of the present invention; and

FIG. 10 depicts a process, according to one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the described embodiments, the various elements illustrated in the figures are provided with two or three digit reference numbers.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” can include any integer number greater than or equal to one, i.e. one, two, three, four, etc. The terms “a plurality” can include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

A community network represents one or more links between data sources associated with users having common interests and/or scheduled/desired activities. Data sources can include data captured by various applications that a user interacts with directly or indirectly. For example, users often interact with a number of electronic devices, such as mobile devices, tablet computers, laptop computers, desktop computers and the like to schedule activities. Some users also interface with electronic devices that monitor personal health/fitness, monitor geographic location, monitor entry/exit times at access control systems, and other such electronic devices. Other data sources can be, for example, a global positioning system (GPS) signal that identifies people in similar locations at certain moment of time, Bluetooth signal connections between devices, access card reading from various facilities that show time correlation, biometric identifier (e.g., fingerprint, eye reader, etc.), a radio-frequency identification (RFID) reader that uniquely identifies people in a certain location, facial recognition software that places people in the same building, image recognition tools that place two cars or transportation vehicles in close proximity, and the like.

When a user attempts to broadcast messages electronically to a wide audience in search of others with similar interests or involved in similar activities, a large amount of communication bandwidth and storage capacity can be unnecessarily consumed. For example, sending out an e-mail message across a community of users can result in the same message being transmitted to many more recipients than can reasonably be expected to have a shared interest. Further, the use of electronic bulletin board systems for posting and reading shared messages is not effective, as users must actively seek out such systems and sift through potentially irrelevant and/or outdated information. Users can be reluctant to engage with electronic bulletin board systems due to possible security concerns; as such information can be readily accessible by people who do not share a true interest in the associated activity.

Embodiments of the present invention address the above technical challenges by using both current data of common activity, historical data where similar events occurred, and an association of personal relationships extracted from the Internet/social media where a connection is established through the amount and quality of data exchanged on these platforms. Further examples include cross referencing material published on the Internet by people, sentiment analysis of material published to assess affinity and to remove connections that may have adversity build into it, proximity of a living/dwelling in geographical locations and the utilization of public services (e.g., library, schools, community centers), and assessing common activity that extend beyond a person to people living with the person in the same house and interacting with closely related people of the other person. Data driven aggregation methods are developed based on the trustworthiness of the data, historical trends learned from public/private data sources, and potential connectivity based on similarity in behavior, interest and past activity to predictively form groups of linked sources as one or more community networks absent direct group formation requests from the sources of data across a communication network. Each user can be provided with a capability to rank activities and use these rankings as a trust index of connectivity between people. Embodiments of the invention leverage the observation that electronic devices with which a user directly and/or indirectly interfaces collectively produce a data source to track where the user has been and where the user will likely be at a particular day and time. Embodiments of the invention collect data from many users and determine how to efficiently use the data while reducing redundant data transfers and storage for coordinating user activities. Data source providers, according to embodiments of the invention, can pool access to data including scheduling, location tracking, and activity tracking from multiple sources within a defined geographical area. Patterns from the data indicating predicted overlaps can be used to dynamically create one or more groups of data source providers and suggest cooperative interactions.

Based on historical data of activities carried out by an individual, classifying algorithms can be used to identify activities, and one or more potential schedules for an individual can be generated by embodiments. The schedules are confirmed by individuals based on intent, and shared schedules can be distributed to multiple people who may have the same interest and share common interest or are tagged as possible connecting segments.

It is understood in advance that although this detailed description includes a detailed description on cloud computing, implementation of the teachings recited herein are not limited to a cloud computing environment. Rather, embodiments of the present invention are capable of being implemented in conjunction with any other type of computing environment now known or later developed. One such example is direct interaction between mobile devices where a cellular link may not be used but rather a Bluetooth or Wi-Fi connection is created between the mobile devices, information is transferred, and a schedule is created.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

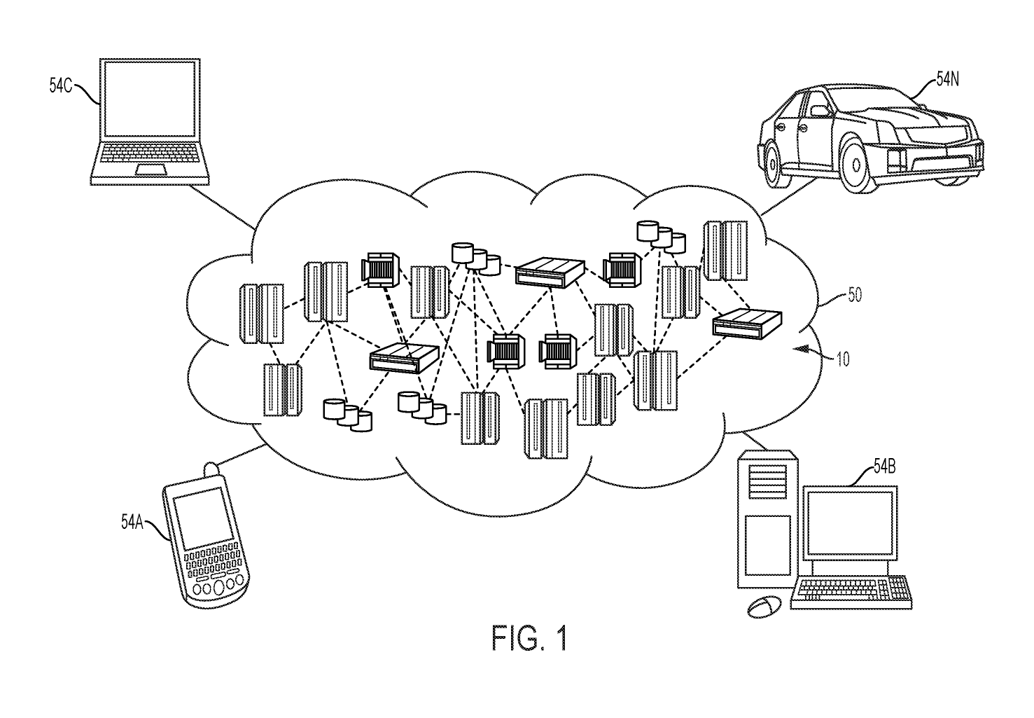

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

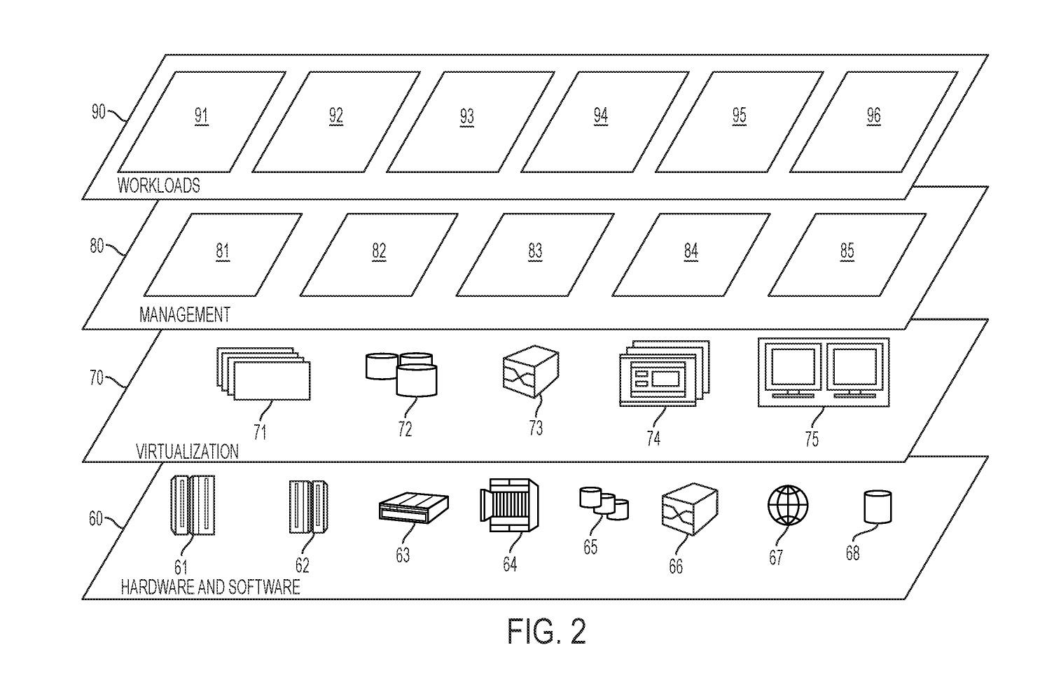

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and adaptive policy adjustment 96.

Turning now to an overview of technologies that are more specifically relevant to aspects of the invention, embodiments can use cloud-based computing and/or other computing architectures that enable the exchange of data over a communication network. A communication network refers any combination of network segments that support an exchange of electronic data, such as a wide area network, an intranet, the Internet, and the like. A communication network can include any combination of wired, wireless, and/or optical transmission media.

Turning now to an overview of the aspects of the invention, one or more embodiments of the invention address the above-described shortcomings of the prior art by scheduling data associated with a plurality of users can be gathered from data sources across a communication network, where the data sources are associated with a defined geographic area. The defined geographic area can be established based at least in part on various levels of scale, such as a neighborhood, a school district, a town, a county, and the like. One or more shared activities and interests can be identified based at least in part on the scheduling data. One or more community networks can be created that link two or more of the data sources based at least in part on the one or more shared activities and interests, and notifications associated with the one or more shared activities and interests can be distributed across the one or more community networks.

The above-described aspects of the one or more embodiments of the present invention address the above-described shortcomings of the prior art by dynamically clustering data sources from two or more users into one or more groups based at least in part on identifying one or more activities or interests tagged with a same name or a similar name from the one or more shared activities and interests. Filtering can be applied to the one or more groups based at least in part on at least one overlapping time slot and at least one shared attribute. A shared attribute can include having household members enrolled in a same activity, within a common age range, and/or other common features. The one or more groups can be merged into the one or more community networks based at least in part on an overlapping membership of the users. Technical benefits can include peer-to-peer data exchanges with centralized analysis and predictive group formation of data sources to reduce redundant data and recordkeeping. Ad hoc formation and use of community networks can reduce arbitrary data exchanges over a communication network between the data sources in search of matches and does not require preexisting knowledge of group options by users seeking cooperative interactions.

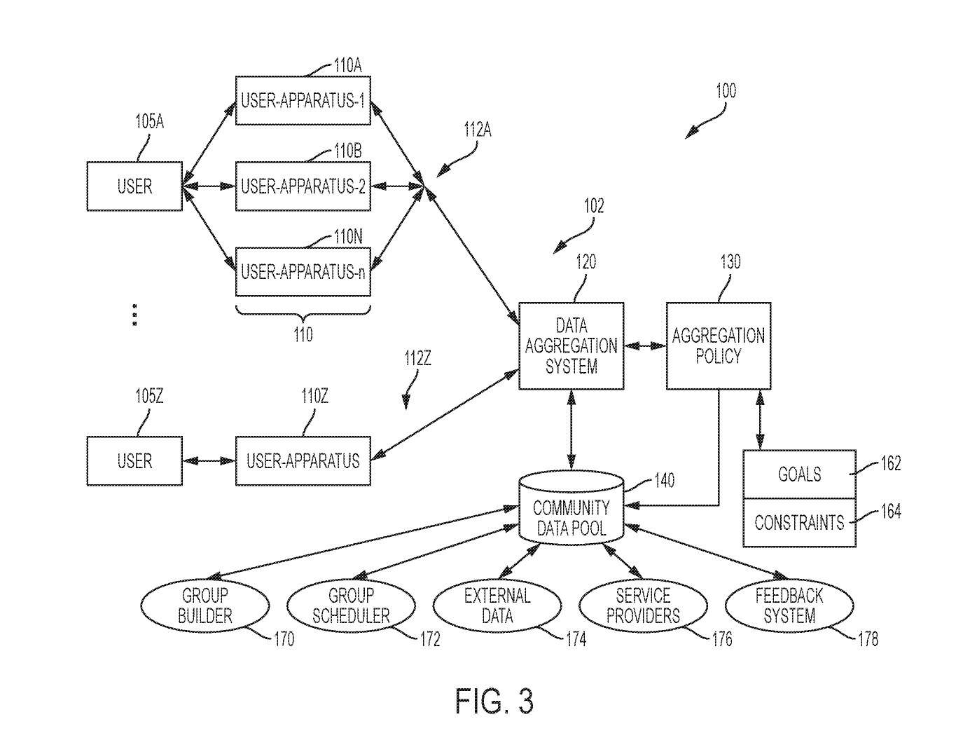

Turning now to a more detailed description of aspects of the present invention, FIG. 3 depicts a system 100 for community network creation and management, according to one or more embodiments of the present invention. In one or more examples, the system 100 is implemented using the cloud computing platform as described herein. For example, the system 100 can include one or more server computers that are accessed over a communication network 102.

In one or more examples, the system 100 includes one or more user-apparatus 110, such as mobile devices, tablet computers, wearable devices, laptop computers, personal computers, access control systems, and other such type of apparatus, which can be generally referred to as devices that facilitate acquiring user data directly from user input or indirectly from sensed conditions. For example, user-apparatus 110A can be a smartphone that user 105A uses to manually enter scheduling information for activities and can also track sensed data (e.g., step-counter, heart-rate monitor, position/location data, etc.) for analysis. The user 105A can also interface with user-apparatus-2 110B up to a user-apparatus-N 110N, which can include personal fitness tracking devices, entry/exit monitors in smart homes, vehicle-based systems, and the like. Other users, such as user 105Z, can use one or more other user-apparatus 110Z to input scheduling information, interests, and/or interface with social media. Information can be captured through a calendar application, a dashboard interface, and/or other data gathering application.

Data generated directly and/or indirectly by user-apparatus-1 110A through user-apparatus-n 110N for user 105A represents a data source 112A. Data generated directly and/or indirectly by user apparatus 110Z for user 105Z represents a data source 112Z. Users 105A-105Z can be identified as having an association with a defined geographic area based at least in part on the location of their respective residences, places of business, school locations, or other groupings. The defined geographic area can be bounded at a neighborhood level, a town level, or other defined level. A data aggregation system 120 can identify the data sources 112A-112Z associated with a defined geographic area and gather scheduling data associated with the users 105A-105Z from the data sources 112A-112Z across the communication network 102. The data aggregation system 120 can be located on one or more servers and/or implemented as a cloud-based service.

The data aggregation system 120 can interface with an aggregation policy 130 that defines how activity data, social media data, interest data, and other such types of data from the data sources 112A-112Z should be combined and/or grouped. The data aggregation system 120 can populate a community data pool 140 with information from the data sources 112A-112Z and tag data according to the aggregation policy 130. Although the community data pool 140 is depicted as a single entity, it will be understood that the community data pool 140 can be distributed as content addressable portions of memory distributed between multiple machines. The aggregation policy 130 can be defined based at least in part on a plurality of goals 162 and constraints 164 that limit how grouping and potential merging into linked community networks should be performed. For example, the goals 162 can include seeking ride sharing opportunities, seeking event creation for time periods, providing weighted preferences based at least in part on physical proximity, and other such grouping goals. The constraints 164 can apply limits to grouping preferences such as grouping based at least in part on time constraints, health profile, gender, age, social factors, economic factors, environmental factors, faith/religion factors, and other such limitations.

Once the community data pool 140 is formed and tagged according to the aggregation policy 130, a group builder 170 can determine how to efficiently define one or more groups based at least in part on activity and/or interest data. A group scheduler 172 can determine how to efficiently schedule coordination of group members for existing activities or future activities based at least in part on interests and/or additional information. In some embodiments, external data 174 such as social media data sources can be accessed to identify contacts, historical locations, interests, and/or other information. The community data pool 140 can be used by a variety of service providers 176 interested in offering the users 105A-105Z opportunities related to shared activities and interests. In some embodiments, the users 105A-105Z can be service providers 176 by offering to share rides, host events, lead group outings, or other such shared actions. The service providers 176 can also include third parties, such as businesses seeking to fulfill expressed interests or predicted interests of the users 105A-105Z. For instance, the service providers 176 can include specialty stores, community education providers, outdoor activity providers, fitness program providers, childcare providers, and other such providers that can provide energy efficiency, enhanced security, and/or improved environmental preparedness to the users 105A-105Z.

Results of the use of service providers 176 can be tracked using a feedback system 178. The feedback system 178 can be a rating system that indicates how well previous offers were fulfilled by the service providers 176. The system 100 can also implement a form of digital currency to encourage participation. For instance, users 105A-105Z can be issued digital currency credit in exchange for allowing the data sources 112A-112Z to be made available to community data pool 140. Users 105A-105Z who use services provided by the service providers 176 can exchange digital currency with the service providers 176, and users 105A-105Z that act as service providers 176 can receive digital currency in exchange for services provided. As an example, conventional digital currency systems can be used or a customized block-chain-based currency system can be locally employed for the defined geographic area of the users 105A-105Z of system 100.

It should be noted that although FIG. 3 depicts the data aggregation system 120, aggregation policy 130, group builder 170, group scheduler 172, and feedback system 178 as separate entities, in one or more examples, the system 100 can implement the data aggregation system 120, aggregation policy 130, group builder 170, group scheduler 172, and/or feedback system 178 as one or more sub-combinations or on a single machine.

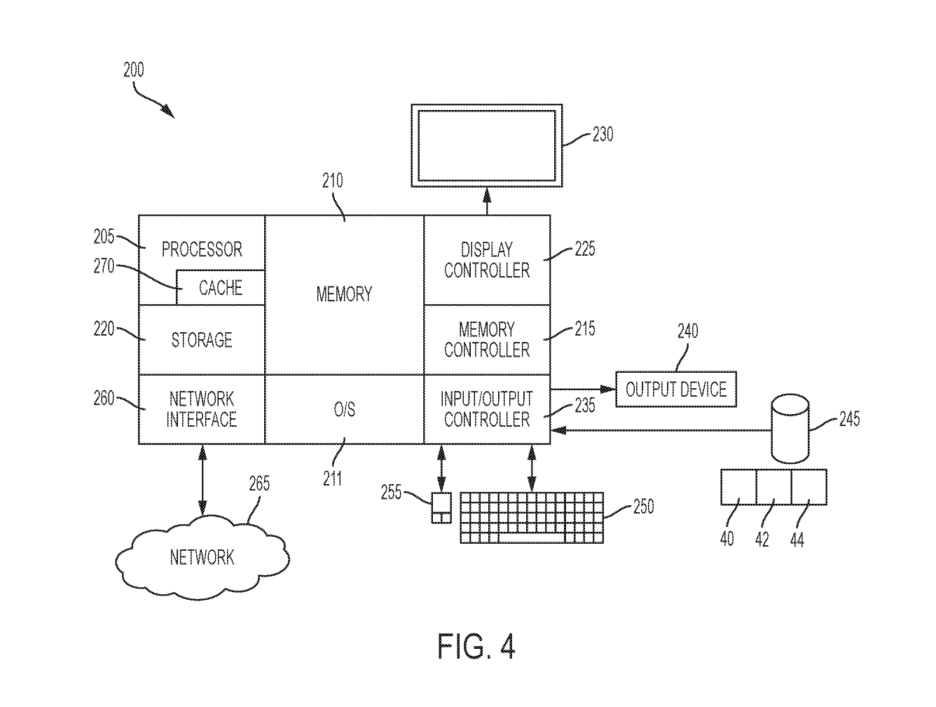

FIG. 4 depicts a computer system 200, according to one or more embodiments of the present invention. The communication apparatus can be a computer, such as a server, a laptop computer, a tablet computer, a phone, and the like. The computer system 200 can be used as any one or more of the apparatus/system depicted in FIG. 3, such as the user-apparatus 110, data aggregation system 120, group builder 170, group scheduler 172, service providers 176, feedback system 178, or a combination thereof.

The computer system 200 includes, among other components, a processor 205, memory 210 coupled to a memory controller 215, and one or more input devices 245 and/or output devices 240, such as peripheral or control devices, that are communicatively coupled via a local I/O controller 235. These devices 240 and 245 can include, for example, battery sensors, position/motion sensors (altimeter 40, accelerometer 42, GPS 44), indicator/identification lights, cameras, microphones, speakers, and the like. Input devices such as a conventional keyboard 250 and mouse 255 can be coupled to the I/O controller 235. The I/O controller 235 can be, for example, one or more buses or other wired or wireless connections, as are known in the art. The I/O controller 235 can have additional elements, which are omitted for simplicity, such as controllers, buffers (caches), drivers, repeaters, and receivers, to enable communications.

The I/O devices 240, 245 can further include devices that communicate both inputs and outputs, for instance disk and tape storage, a network interface card (MC) or modulator/demodulator (for accessing other files, devices, systems, or a network), a radio frequency (RF) or other transceiver, a telephonic interface, a bridge, a router, and the like.

The processor 205 (also referred to as a processing circuit) is a hardware device for executing hardware instructions or software (e.g., program instructions), particularly those stored in memory 210. The processor 205 can be a custom made or commercially available processor, a central processing unit (CPU), an auxiliary processor among several processors associated with the computer system 200, a semiconductor-based microprocessor (in the form of a microchip or chip set), a macroprocessor, or other device for executing instructions. The processor 205 includes a cache 270, which can include, but is not limited to, an instruction cache to speed up executable instruction fetch, a data cache to speed up data fetch and store, and a translation lookaside buffer (TLB) used to speed up virtual-to-physical address translation for both executable instructions and data. The cache 270 can be organized as a hierarchy of more cache levels (L1, L2, and so on.).

The memory 210 can include one or combinations of volatile memory elements (for example, random access memory, RAM, such as DRAM, SRAM, SDRAM) and nonvolatile memory elements (for example, ROM, erasable programmable read only memory (EPROM), electronically erasable programmable read only memory (EEPROM), programmable read only memory (PROM), tape, compact disc read only memory (CD-ROM), disk, diskette, cartridge, cassette or the like). Moreover, the memory 210 can incorporate electronic, magnetic, optical, or other types of storage media. Note that the memory 210 can have a distributed architecture, where various components are situated remote from one another but can be accessed by the processor 205.

The instructions in memory 210 can include one or more separate programs, each of which includes an ordered listing of executable instructions for implementing logical functions. In the example of FIG. 4, the instructions in the memory 210 include a suitable operating system (OS) 211. The operating system 211 essentially can control the execution of other computer programs and provides scheduling, input-output control, file and data management, memory management, and communication control and related services.

Additional data, including, for example, instructions for the processor 205 or other retrievable information, can be stored in storage 220, which can be a storage device such as a hard disk drive or solid state drive. The stored instructions in memory 210 or in storage 220 can include those enabling the processor to execute one or more aspects of the systems and methods described herein.

The computer system 200 can further include a display controller 225 coupled to a user interface or display 230. In some embodiments, the display 230 can be an LCD screen. In other embodiments, the display 230 can include a plurality of LED status lights. In some embodiments, the computer system 200 can further include a network interface 260 for coupling to a network 265. The network 265 can be an IP-based network for communication between the computer system 200 and an external server, client and the like via a broadband connection. In an embodiment, the network 265 can be a satellite network. The network 265 transmits and receives data between the computer system 200 and external systems. In some embodiments, the network 265 can be a managed IP network administered by a service provider. The network 265 can be implemented in a wireless fashion, for example, using wireless protocols and technologies, such as WiFi, WiMax, satellite, or any other. The network 265 can also be a packet-switched network such as a local area network, wide area network, metropolitan area network, the Internet, or other similar type of network environment. The network 265 can be a fixed wireless network, a wireless local area network (LAN), a wireless wide area network (WAN) a personal area network (PAN), a virtual private network (VPN), intranet or other suitable network system and can include equipment for receiving and transmitting signals.

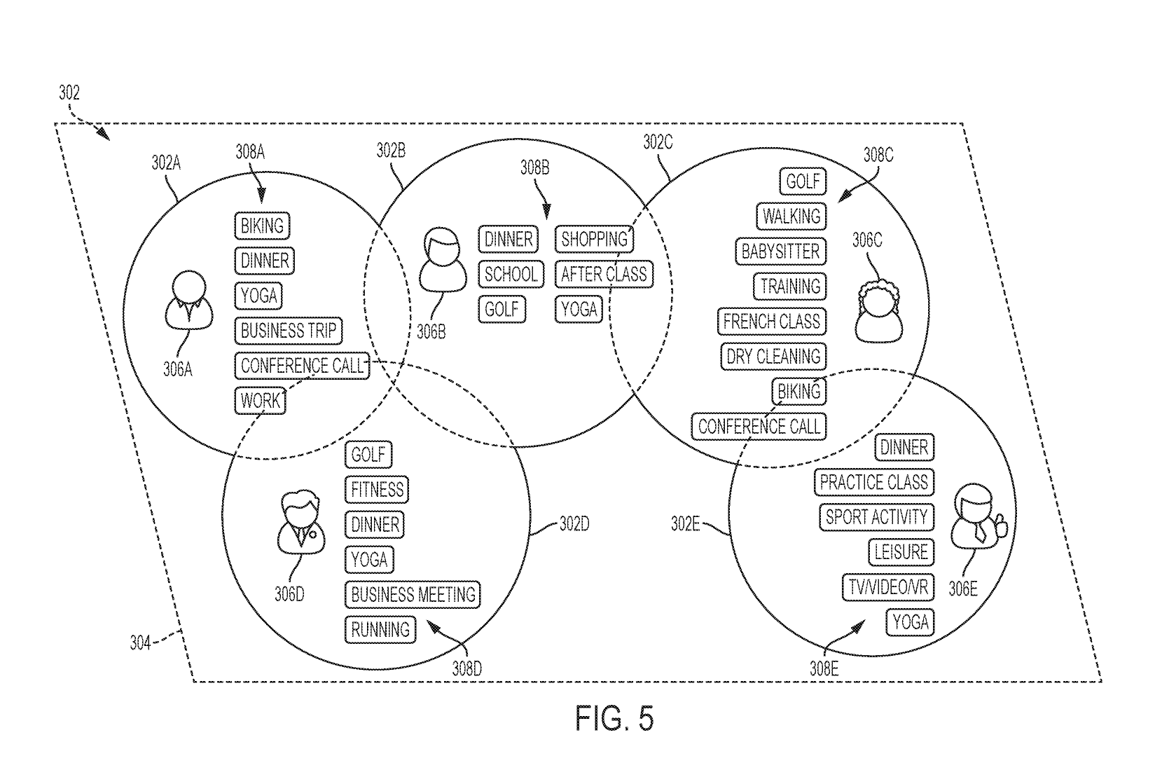

FIG. 5 depicts a plurality of data sources 302 associated with a defined geographic area 304, according to one or more embodiments. In the example of FIG. 5, a data source 302A is defined for user 306A and captures a number of activities and interests 308A, such as biking, dinner, yoga, business trip, conference call, and work. A number of scheduled activities and interests can be marked for potential grouping while others can be marked as private/do not share. For instance, a business trip, conference call, and work can be not marked as a sharable activity unless there is a desire to find one or more partners for shared business travel or commuting. Similarly, data source 302B is defined for user 306B and captures activities and interests 308B, such as dinner, school, golf, shopping, after class, and yoga. Data source 302A can be defined for user 306C to capture activities and interests 308C, such as golf, walking, babysitting, training, French class, dry cleaning, biking, and conference call. Data source 302D can be defined for user 306D to capture activities and interests 308D, such as golf, fitness, dinner, yoga, business meeting, and running. Data source 302E can be defined for user 306E to capture activities and interests 308E such as dinner, practice class, sports activity, leisure, television, and yoga. The data aggregation system 120 can tag the data based at least in part on the aggregation policy 130 of FIG. 3 for the group builder 170 to determine one or more groups to form one or more community networks. Based on known activities of a person in combination with, for instance, cultural, religion, social interest, age, social status and personalities, new activities may be associated with the person that are likely to be of interest. Interests can be static or dynamic, as observed interests may appear and disappear based on time constrains and changing patterns detected in data sources.

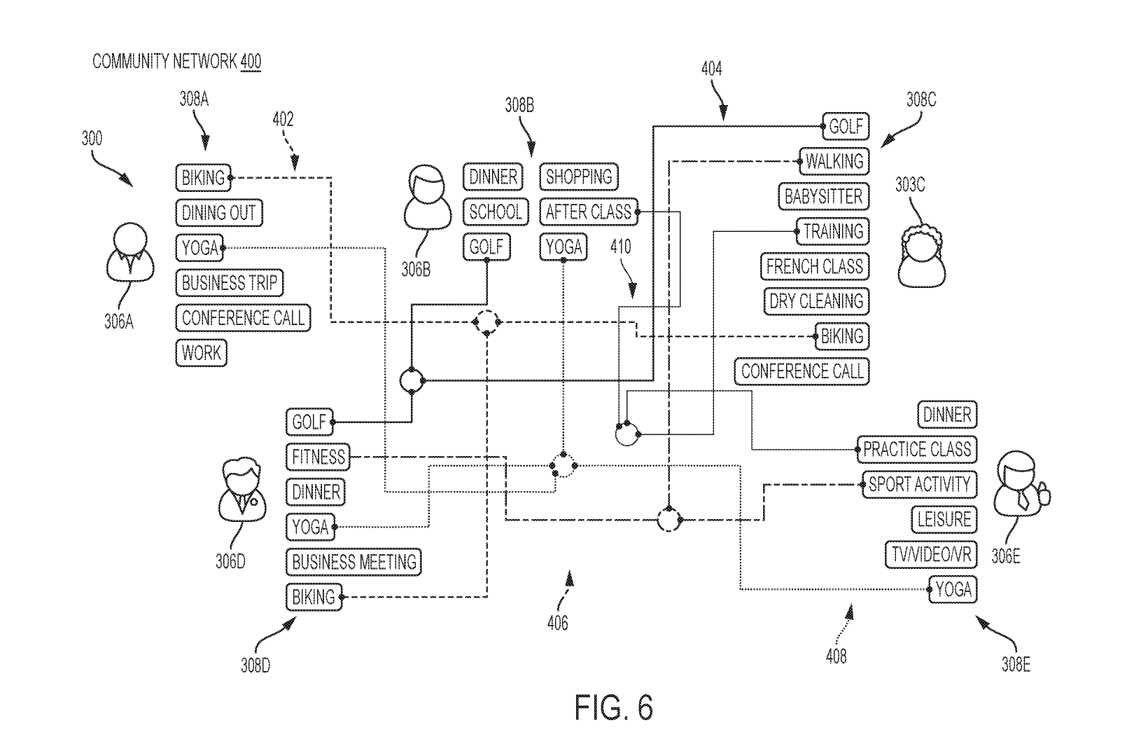

FIG. 6 depicts a community network 400, according to one or more embodiments. The community network 400 can be formed based at least in part on the data source 302 to link common activities and interests between users 306A-306E. The group builder 170 of FIG. 3 can cluster two or more of the users 306A-306E based at least in part on identifying one or more activities and interests 308A-308E tagged with a same name or a similar name from the one or more shared activities and interests. The example of FIG. 6 shows a first link 402 of the community network 400 established for an activity or interest of biking shared by users 306A, 306C, and 306D. A second link 404 is established between users 306B, 306C, and 306D for golf. A third link 406 is established between users 306A, 306D, and 306E for similar terms of walking, fitness, and sports activity. A fourth link 408 is established between users 306B, 306D, and 306E for yoga. A fifth link 410 is established between users 306B, 306C, and 306E for similar terms of after class, training, and practice class. Furthermore, links can be ranked in time to identify overlaps in activities and/or a shared facility or location. Activity interest, time of activity, personal affinity, and/or location may coincide to schedule a common link between user schedules.

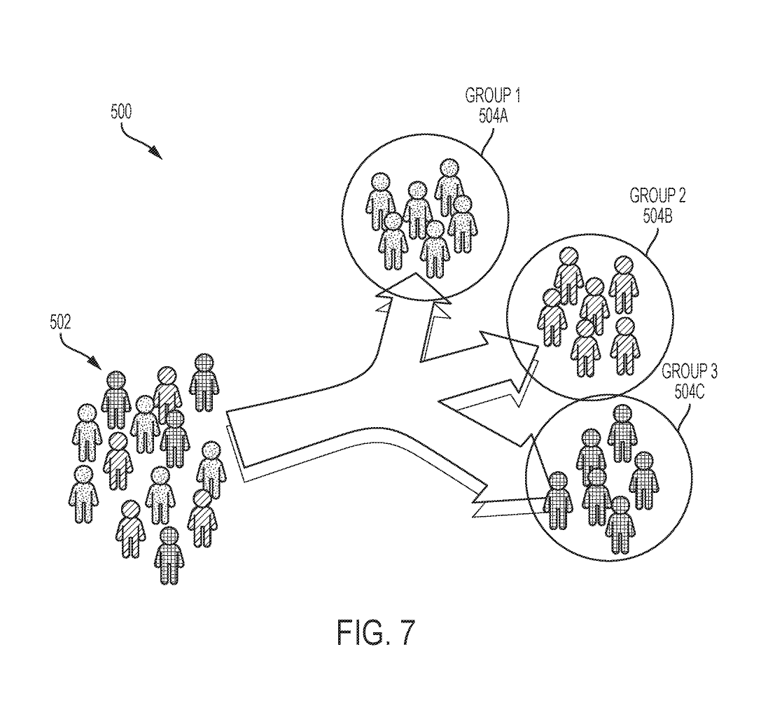

FIG. 7 depicts a grouping process 500, according to one or more embodiments. The grouping of users 502 in groups 504A, 504B, and 504C in the example of FIG. 7 can be based at least in part on a shared calendar or creating a dashboard where users 502 can sign up for various activities. Based at least in part on social relationship extracted from social media profiles, users 502 can be matched based at least in part on a shared interest or need. The grouping can have a short lifetime and can be formed dynamically and disappear once the activities are carried out. Once the matching/grouping is carried out, recommendations can be made for people who are not within one of the groups 504A-504C but share similar attributes. The matching can enable social network extension and identify and attract people that live in close proximity or farther apart but facing similar challenges.

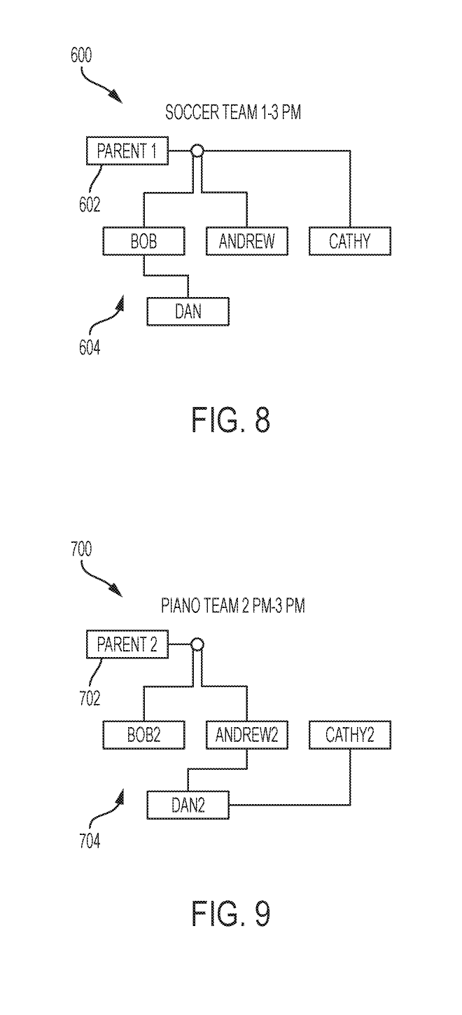

FIGS. 8 and 9 depict graphs matching users to activities according to one or more embodiments. In the example of FIG. 8, a graph 600 includes a parent node 602 and a plurality of child nodes 604. In the example of FIG. 9, a graph 700 includes a parent node 702 and a plurality of child nodes 704. Various connections may be visible to one or more users that are involved in the same activity. Sharing the information may be limited to a set of people and may be prioritized based on the internal rating system of the people, where highly ranked people will command more trust. In case there are multiple people who could be a node in the network, a relationship can be established based on the trust and ranking of the people. Once the connections are established, a person can start aggregating multiple activities and offer a service in which the person will provide, for example, transportation for people to a certain place, will offer supervision of activity for one person or a larger group of people. These services can be offered for a certain monetary reward or may be offered in exchange for similar services. The system 100 can keep track of the exchanged funds or services. The system 100 can also enable posting of a service that is related to an activity, provide information about an activity, and based on an expressed interest, perform matching with users 502 identified as potential clients.

As one example, parent node 602 associated with a user having a child on a soccer team can be identified with transportation capacity for a specific time as a first scheduled activity for a plurality of child nodes 604, and in exchange, a second user associated with parent node 702 can provide transportation for a second activity for a plurality of child nodes 704 that may overlap with the child nodes 604. For instance, mobile devices of users 502 associated with the parent nodes 602, 702 can use exchanged schedule information to determine an efficient allocation of transportation resources. As further examples, associations between users 502 of mobile devices, known family members, and activities can be used to produce multiple offers for shared scheduling of events or completion of tasks. For instance, offers for services such as cooking food, providing transportation, and assisting with other tasks can be facilitated through the system 100 of FIG. 3. Further, data from groups of users 502 can be aggregated for service offers, such as offers of free/discounted classes based on identified interests, schedule availability, and location.

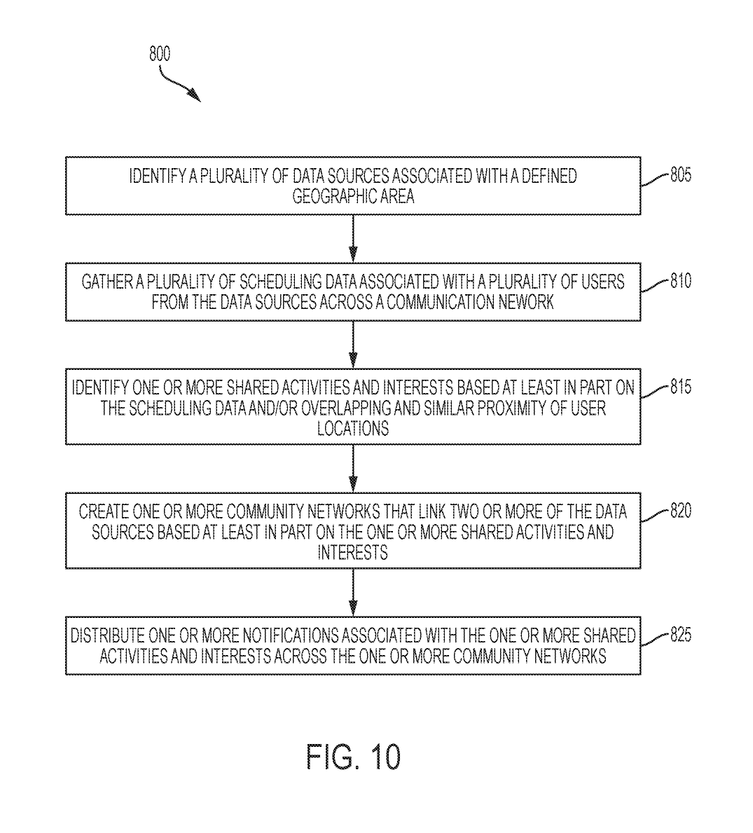

FIG. 10 illustrates a process 800 for community network creation. The process 800 is described with reference to FIGS. 1-10 and can include additional steps beyond those depicted in FIG. 10. The process 800 can be performed by the system 100 of FIG. 3.

At block 805, the system 100 identifies a plurality of data sources 112A-112Z associated with a defined geographic area 304. The data sources 112A-112Z can include one or more of: scheduling data, sign-up dashboard data, location data, activity history data, and sensor data. At block 810, the system 100 gathers a plurality of scheduling data associated with a plurality of users 105A-105Z from the data sources 112A-112Z across a communication network 102. At block 815, the system 100 identifies one or more shared activities and interests based at least in part on the scheduling data.

At block 820, the system 100 creates one or more community networks 400 that link two or more of the data sources 112A-112Z based at least in part on the one or more shared activities and interests. The system 100 can also access social media content associated with the users 105A-105Z, create a list of potential matches for the users 105A-105Z based at least in part on one or more contacts, interests, and location history from the social media content, and use the list to populate the one or more community networks 400. Creation of the one or more community networks 400 can include clustering two or more of the users 105A-105Z into one or more groups 504A-504C based at least in part on identifying one or more activities or interests tagged with a same name or a similar name from the one or more shared activities and interests. Data can be clustered based on historical occurrences of same patterns and locations of the users 105A-105Z. The one or more groups 504A-504C can be filtered based at least in part on at least one overlapping time slot and at least one shared attribute. A desired participation status of the users 105A-105Z in the one or more groups 504A-504C can also be confirmed. The one or more groups 504A-504C can be merged into the one or more community networks 400 based at least in part on an overlapping membership of the users 105A-105Z. The system 100 can periodically adjust membership in the one or more community networks 400 based at least in part on detecting a change in the data sources 112A-112Z. The system 100 can also add or remove at least one link in the one or more community networks 400 based at least in part on adjusting of the membership.

At block 825, system 100 distributes one or more notifications associated with the one or more shared activities and interests across the one or more community networks 400. The one or more notifications can include at least one offer to provide a shared service associated with the one or more shared activities and interests. For example, the system 100 can identify one or more services that can be offered based on an aggregation of the data sources 112A-112Z. The system 100 can also track feedback associated with performance of the shared service and provide a feedback history of previous interactions with a provider of the shared service.

The system 100 can dynamically organize an event based at least in part on a shared interest of one or more groups 504A-504C. For example, if a substantial number of runners is identified, a running race can be suggested as an event and the request flowed through to one or more road race organizers. Further, the system 100 can identify a level of demand associated with the one or more shared activities and interests with respect to time. The system 100 can notify a third-party provider associated with the one or more shared activities and interests of the level of demand. The level of demand can trigger the third-party provider to offer additional incentives or a new offer to meet the demand.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
identifying, by a processor, a plurality of data sources associated with a defined geographic area;
gathering, by the processor, a plurality of scheduling data associated with a plurality of users from the data sources across a communication network;
identifying, by the processor, one or more shared activities and interests based at least in part on the scheduling data and/or overlapping and similar proximity of user locations;
creating, by the processor, one or more community networks that link two or more of the data sources based at least in part on the one or more shared activities and interests; and
distributing one or more notifications associated with the one or more shared activities and interests across the one or more community networks.

2. The computer-implemented method of claim 1, wherein the data sources comprise one or more of: scheduling data, sign-up dashboard data, location data, activity history data, and sensor data.

3. The computer-implemented method of claim 1 further comprising:
accessing social media content associated with the users;
creating a list of potential matches for the users based at least in part on one or more contacts, interests, and location history from the social media content; and
using the list to populate the one or more community networks.

4. The computer-implemented method of claim 1 further comprising:
periodically adjusting membership in the one or more community networks based at least in part on detecting a change in the data sources; and
adding or removing at least one link in the one or more community networks based at least in part on adjusting of the membership.

5. The computer-implemented method of claim 1, wherein creating the one or more community networks comprises:
clustering two or more of the users into one or more groups based at least in part on identifying one or more activities or interests tagged with a same name or a similar name from the one or more shared activities and interests;
clustering data based on historical occurrences of same patterns and locations of the users;
filtering the one or more groups based at least in part on at least one overlapping time slot and at least one shared attribute;
confirming a desired participation status of the users in the one or more groups; and
merging the one or more groups into the one or more community networks based at least in part on an overlapping membership of the users.

6. The computer-implemented method of claim 5 further comprising:
dynamically organizing an event based at least in part on a shared interest of the one or more groups.

7. The computer-implemented method of claim 1, further comprising:
identifying, by the processor, one or more services that can be offered based on an aggregation of the data sources, wherein the one or more notifications comprise at least one offer to provide a shared service associated with the one or more shared activities and interests.

8. The computer-implemented method of claim 7, further comprising:
tracking feedback associated with performance of the shared service; and
providing a feedback history of previous interactions with a provider of the shared service.

9. The computer-implemented method of claim 1 further comprising:
identifying a level of demand associated with the one or more shared activities and interests with respect to time; and
notifying a third-party provider associated with the one or more shared activities and interests of the level of demand.

10. A system comprising:
a memory; and
a processor communicatively coupled with the memory, the processor configured to:
identify a plurality of data sources associated with a defined geographic area;
gather a plurality of scheduling data associated with a plurality of users from the data sources across a communication network;
identify one or more shared activities and interests based at least in part on the scheduling data and/or overlapping and similar proximity of user locations;
create one or more community networks that link two or more of the data sources based at least in part on the one or more shared activities and interests; and
distribute one or more notifications associated with the one or more shared activities and interests across the one or more community networks.

11. The system of claim 10, wherein the processor is further configured to:
access social media content associated with the users;
create a list of potential matches for the users based at least in part on one or more contacts, interests, and location history from the social media content; and
use the list to populate the one or more community networks.

12. The system of claim 10, wherein the processor is further configured to:
periodically adjust membership in the one or more community networks based at least in part on detecting a change in the data sources; and
add or remove at least one link in the one or more community networks based at least in part on adjusting of the membership.

13. The system of claim 10, wherein creation of the one or more community networks comprises:
clustering two or more of the users into one or more groups based at least in part on identifying one or more activities or interests tagged with a same name or a similar name from the one or more shared activities and interests;
clustering data based on historical occurrences of same patterns and locations of the users;
filtering the one or more groups based at least in part on at least one overlapping time slot and at least one shared attribute;
confirming a desired participation status of the users in the one or more groups; and
merging the one or more groups into the one or more community networks based at least in part on an overlapping membership of the users.

14. The system of claim 10, wherein the one or more notifications comprise at least one offer to provide a shared service associated with the one or more shared activities and interests, and the processor is further configured to:
track feedback associated with performance of the shared service; and
provide a feedback history of previous interactions with a provider of the shared service.

15. The system of claim 10, wherein the processor is further configured to:
identify a level of demand associated with the one or more shared activities and interests with respect to time; and
notify a third-party provider associated with the one or more shared activities and interests of the level of demand.

16. A computer program product comprising a computer readable storage medium having program instructions embodied therewith, the program instructions executable by a processing circuit to cause the processing circuit to:
identify a plurality of data sources associated with a defined geographic area;
gather a plurality of scheduling data associated with a plurality of users from the data sources across a communication network;
identify one or more shared activities and interests based at least in part on the scheduling data and/or overlapping and similar proximity of user locations;
create one or more community networks that link two or more of the data sources based at least in part on the one or more shared activities and interests; and
distribute one or more notifications associated with the one or more shared activities and interests across the one or more community networks.

17. The computer program product of claim 16, wherein the program instructions are further executable to cause the processing circuit to:
access social media content associated with the users;
integrate data from mobile devices.
create a list of potential matches for the users based at least in part on one or more contacts, interests, and location history from the social media content; and
use the list to populate the one or more community networks.

18. The computer program product of claim 16, wherein the program instructions are further executable to cause the processing circuit to:
periodically adjust membership in the one or more community networks based at least in part on detecting a change in the data sources; and
add or remove at least one link in the one or more community networks based at least in part on adjusting of the membership
create ranking of the people based on quality of work, type of interactions and services offered.

19. The computer program product of claim 16, wherein creation of the one or more community networks comprises:
clustering two or more of the users into one or more groups based at least in part on identifying one or more activities or interests tagged with a same name or a similar name from the one or more shared activities and interests;
clustering data based on historical occurrences of same patterns and locations of the users;
filtering the one or more groups based at least in part on at least one overlapping time slot and at least one shared attribute;
confirming a desired participation status of the users in the one or more groups; and
merging the one or more groups into the one or more community networks based at least in part on an overlapping membership of the users.

20. The computer program product of claim 16, wherein the one or more notifications comprise at least one offer to provide a shared service associated with the one or more shared activities and interests, and the program instructions are further executable to cause the processing circuit to:
track feedback associated with performance of the shared service; and
provide a feedback history of previous interactions with a provider of the shared service.
